(19) United States
(12) Patent Application Publication
(10) Pub. No.: US 2007/0247834 A1
(43) Pub. Date: Oct. 25, 2007

(54) Brite vest

(76) Inventor: Rodney Ray Turner, Clarkston, GA (US)

Correspondence Address: Rodney Ray Turner, Apt. C-1, 822 N. Indian Creek Drive, Clarkston, GA, 30021, US

(21) Appl. No.: 11/409,656

(22) Filed: Apr. 24, 2006

(51) Int. Cl. F21V 21/08

(52) U.S. Cl. 362/103

(57) ABSTRACT

The Brite Vest is an improvement to the standard traffic or safety vest in that it provides its own illumination during hours of darkness. The conventional vest relies on the illumination provided by a drivers headlights. Many times the distance at which a person is visible when wearing a conventional is too close to provide adequate time to stop. The Brite Vest provides additional visibility which translates into additional safety.

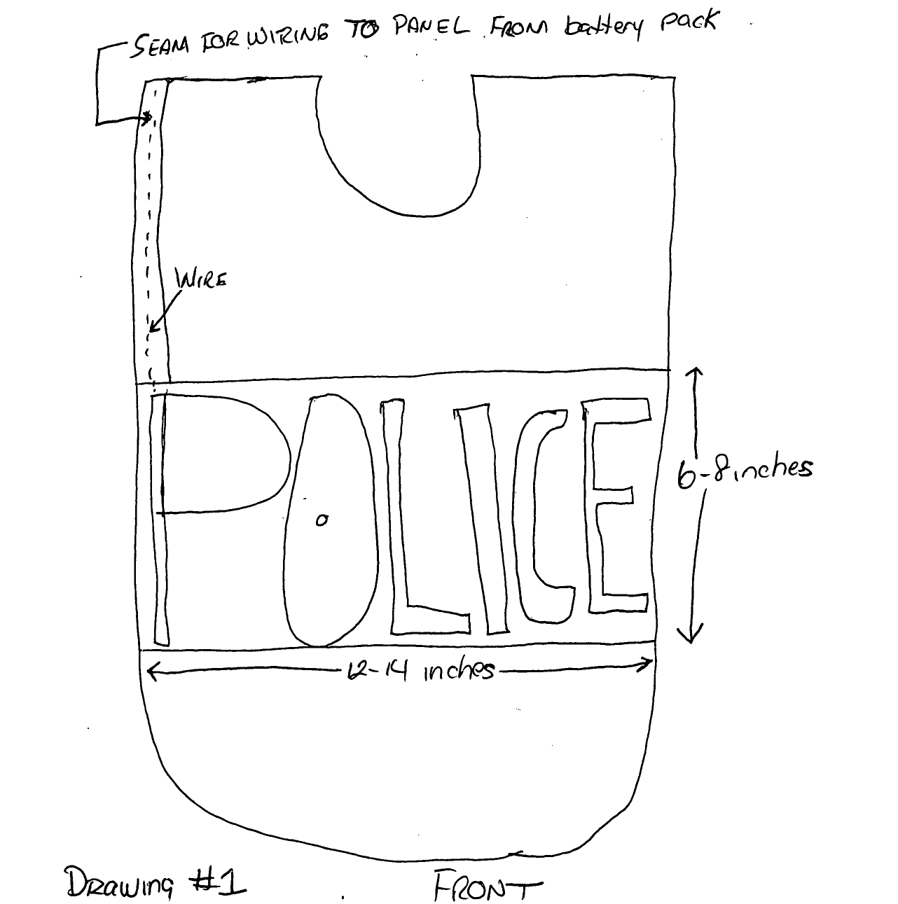

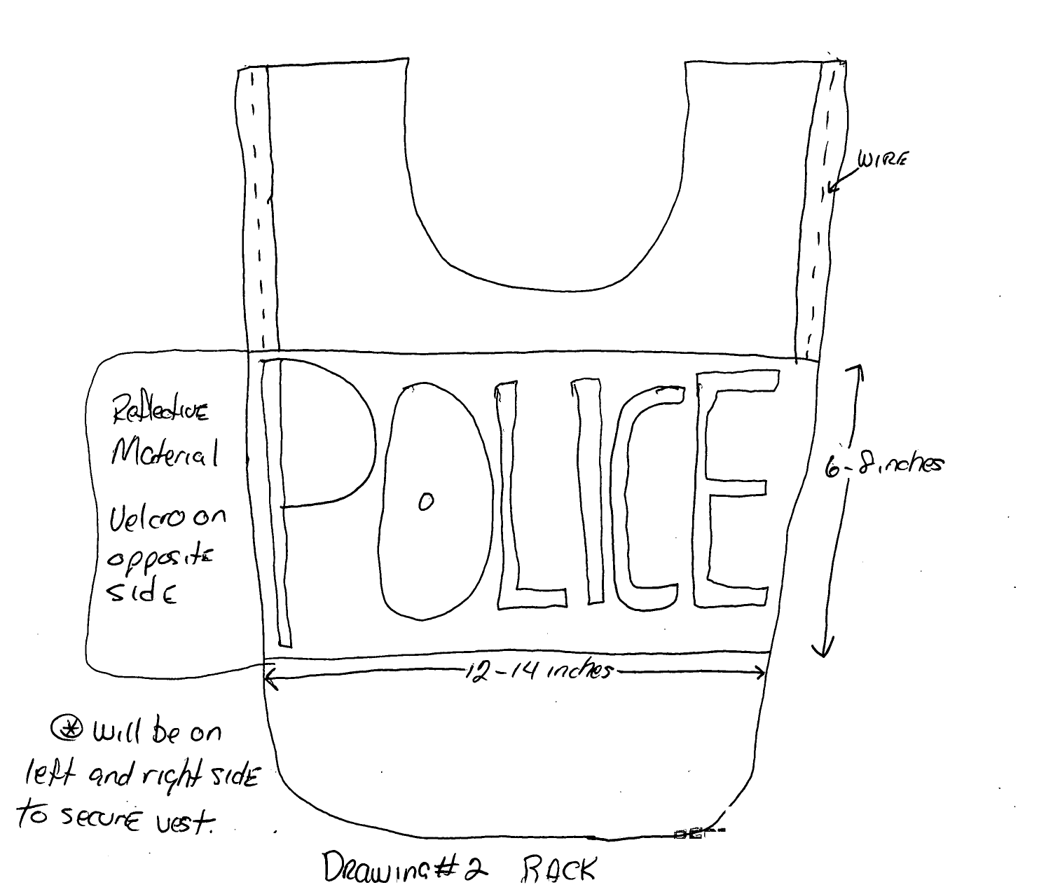

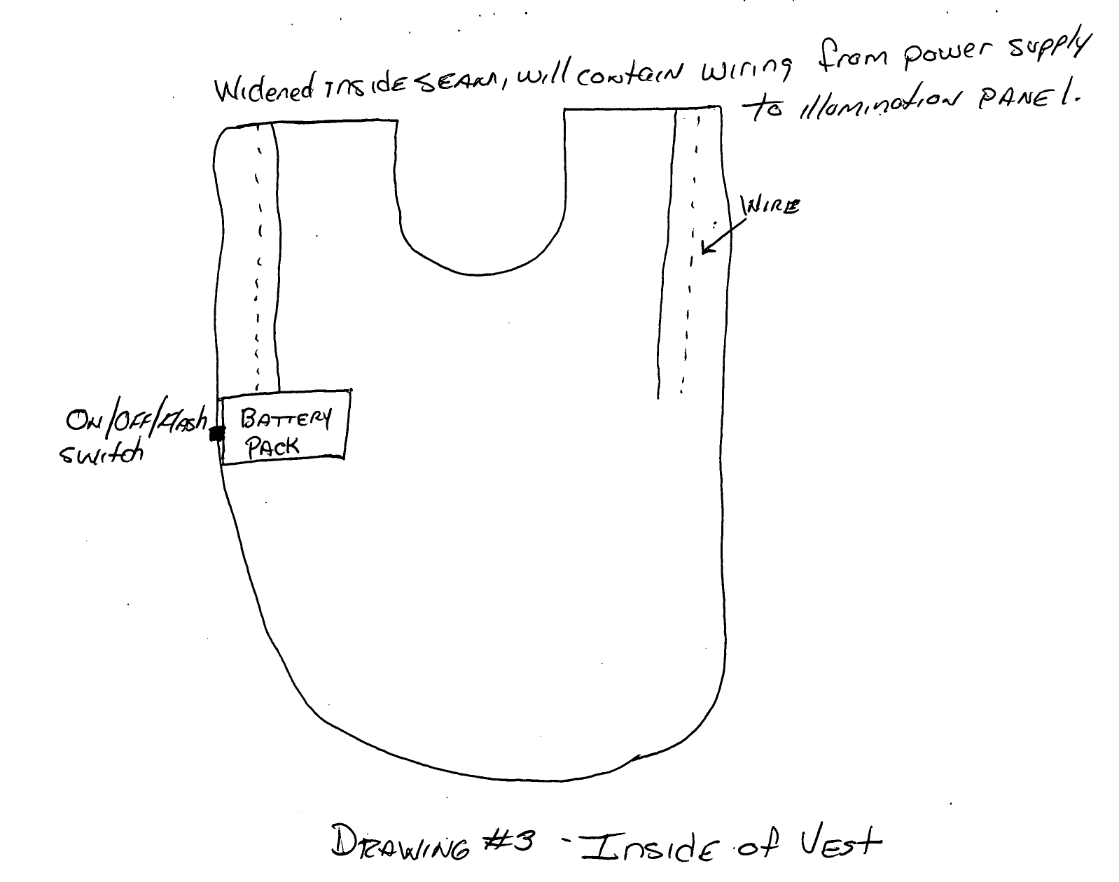

### BACKGROUND OF THE INVENTION

As a 14 year Law Enforcement veteran I have spent many hours directing traffic in low light or night time conditions and the invention came from the desire to have a higher degree of safety. Many motorists told myself and other officers that the reason they came so close to hitting an officer is that they could not see him. This was despite the wearing of traditional reflective vests and using flashlights equipped with colored cones.

### BRIEF SUMMARY OF THE INVENTION

The Brite Vest, invented by Rodney R. Turner is an improvement over the current traffic vest used by Law Enforcement when directing traffic or by the general public when biking, roller blading or jogging. When equipped with the flashing/steady light panel the vest provides enhanced safety by making the wearer significantly more visible to motorists.

### BRIEF DESCRIPTION OF THE VIEWS OF THE DRAWINGS

Image #1 shows the front of the device. It includes a sample of the illuminated panel with ‘POLICE’ being shown. The base of the device is the traditional traffic vest using the over the head design. The vest will be secured by Velcro on both sides. Image #2 will show the rear of the device which matches the front in both size and content. Image #3 will show the inside of the vest, including the battery pack and wiring used to provide power to the front and rear panels.

### DETAILED DESCRIPTION OF THE INVENTION

The Brite Vest is equipped with a flashing/steady light panel that provides enhanced safety by making the wearer significantly more visible to motorists. Instead of being dependent on the illumination provided by a drivers headlights striking reflective material on the vest the product will provide its own illumination with either a steady on or flashing setting. In reference to the general population the vest will provide the same degree of safety for persons riding bicycles, jogging, or other outdoor activities conducted during nighttime or early morning hours prior to sunrise and at dusk when visibility is limited. The lighted panels will be sewn on in the same manner as conventional reflective only panels. The seam that forms the shoulder area on a normal vest will be widened on the inside closest to the body to allow wiring from the power supply to the light source to provide illumination. The battery(s) will be encased in a water proof plastic container also on the inside of the vest to provide extra weather related protection. The material used will be a solid, water proof material instead of the mesh type used commonly in traffic vests. This of course is to provide weather and water related protection to the panels and wiring of the vest. The vest will be the over the head style and will be secured by Velcro on either side. The outside of this strap will have reflective material on it to provide extra protection for the wearer should their side be facing traffic. These closures will also be approximately 6-8 inches wide to provide an adequate surface area for oncoming headlights. The vest will also be able to be used during daylight hours as is the case with the traditional vest.

1. The BRITE VEST is a battery powered illuminated traffic vest that will have a steady on and a flashing setting. It will be used both for Law Enforcement and civilian or general public use. Panels to be used on the vest will include: POLICE, FIRE, EMT, SHERIFF, DOT, JOGGER, CYCLIST, CAUTION, TROOPER. References to ‘lighted’, ‘flashing’, ‘glowing’, ‘illuminated’, ‘neon’ are also included as protected references or titles.
